(19) United States
(12) Patent Application Publication
(10) Pub. No.: US 2013/0195949 A1
(43) Pub. Date: Aug. 1, 2013

(54) Antimicrobial Layer For Chromatographic Containers

(71) Applicants: Kevin D. Wyndam, Upton, MA (US); Edouard S.P. Bouvier, Stow, MA (US); Pamela C. Iraneta, Brighton, MA (US)

(72) Inventors: Kevin D. Wyndam, Upton, MA (US); Edouard S.P. Bouvier, Stow, MA (US); Pamela C. Iraneta, Brighton, MA (US)

(73) Assignee: WATERS TECHNOLOGIES CORPORATION, Milford, MA (US)

(21) Appl. No.: 13/695,815

(22) PCT Filed: Jun. 27, 2011
(86) PCT No.: PCT/US11/41958

§ 371 Date: Jan. 15, 2013

Related U.S. Application Data
(60) Provisional application No. 61/359,574, filed on Jun. 29, 2010.

(51) Int. Cl. A01N 25/08

(52) U.S. Cl. CPC A01N 25/08
USPC 424/409; 424/618

(57) ABSTRACT

A chromatographic container (1) incorporating an antimicrobial layer (5) or an antimicrobial device (10) with such a layer (15) for use with a standard chromatographic container (11), which layer (5, 15) inhibits, in use, microbial growth. The antimicrobial layer (5, 15) can be on an internal surface of the container (1) or on an exposed surface of the device (10) and may be in the form of a coating, liner or film The layer (5, 15) may be configured for gradual release an antimicrobial agent or chemical additive, for example sodium azide. Additionally or alternatively, the antimicrobial layer (5, 15) may include silver or silver particles, for example nanoparticles of silver.

### RELATED APPLICATION

This application claims priority to and the benefit of U.S. provisional application no. 61/359,574, filed Jun. 29, 2010, the entirety of which is incorporated by reference herein.

### BACKGROUND ART

This invention relates generally to antimicrobial coatings, particularly for use in chromatographic containers.

The applicants have observed that microbial growth poses a real problem for chromatographers, particularly in predominantly aqueous solvent bottles. Microbes formed under these conditions can flow through the High Pressure Liquid Chromatography (HPLC) system, leading to contamination of the system, check valves, injector, filters, guard columns, chromatographic columns (HPLC, UPLC, GPC, SPE) and detectors.

Microbial contamination of guard columns and chromatographic columns can lead to frit and bed blockage, which leads to increased system pressures. This increase in system pressure can lead to serious issues and, ultimately, to column failure. Also, bacterial contamination can affect adversely the efficiency of the columns, leading to a loss in resolution.

### SUMMARY OF THE INVENTION

A first aspect of the invention provides a chromatographic container comprising a layer, e.g. an antimicrobial layer, that inhibits, in use, microbial growth on the layer and/or in the container.

The layer may be on an internal surface of the container.

A second aspect of the invention provides an antimicrobial device for use in a chromatographic system or container, e.g. a chromatographic system or container antimicrobial device, the device comprising a substrate with a layer thereon that inhibits, in use, microbial growth on the layer and/or in a container within which the device is at least partially received.

The layer may be on an exposed and/or external or internal surface of the device.

The provision of an antimicrobial layer and/or device precludes the need for users to take additional steps to prevent microbe growth within the solvent bottles, especially where long term storage of samples is required. More specifically, the invention provides reduced microbe formation without leaching of mass spectrometry visible ions, e.g. by the possible addition of a cartridge of ion-sequestering material located in the fluid path.

The layer may comprise a coating, liner or film and/or may be a thin (e.g., 1 nanometer to 1,000 nanometer) layer or coating or liner or film.

Additionally or alternatively, the layer may be configured to release an antimicrobial agent or chemical additive, for example sodium azide, e.g. the layer may be configured for slow and/or gradual release of the antimicrobial agent.

Additionally or alternatively, the layer may comprise silver or silver particles, for example a silver modified layer, e.g. the layer may comprise nanoparticles of silver.

The use of a slow release antimicrobial agent or chemical additive or silver or silver particles in the layer provides the desired reduction in microbe growth and permits users to keep highly acqueous mobile phase solutions for extended time periods without special precautions. Nanoparticle and chemical bleed should be low, but may be further reduced with an appropriate addition of a solid phase extraction device within the solvent line leading from the solvent reservoir.

The container may comprise a solvent bottle, a vial, e.g. a sample vial, or a collection container (e.g. vial or plate). The container may further comprise solid phase extraction containers, plates, connecting tubing and/or fittings.

The device may comprise a cartridge or a plate, e.g. an impregnated cartridge or plate, which may include the layer thereon or therein. Additionally or alternatively, the device may comprise one or more of a mobile phase sinker, sparge stone, fritted material, filter, tubing, mixer or other wetted part.

A third aspect of the invention provides a chromatographic container containing a device according to the second aspect of the invention.

A fourth aspect of the invention provides a container as described above that contains a chromatographic solvent.

A fifth aspect of the invention provides a chromatographic solvent stored in a container as described above.

A further aspect of the invention provides a chromatographic system or liquid chromatograph comprising a device as described above.

Implementations may provide one or more of the following advantages.

Certain implementations help to inhibit microbial contamination of components (e.g., guard columns and/or chromatographic columns) in chromatography systems.

Some implementations provide a means of combating microbial growth in solvent bottles for chromatographic equipment.

### BRIEF DESCRIPTION OF THE DRAWINGS

Embodiments of the invention will now be described by way of example only with reference to the accompanying drawings in which:

FIG. 1 is a front view of a chromatographic solvent bottle according to a first embodiment of the invention;

FIG. 2 is an enlarged section view of area A of FIG. 1;

FIG. 3 is a perspective view of an antimicrobial device according to a second embodiment of the invention;

FIG. 4 is a section view through line B-B of FIG. 3; and

FIG. 5 is a front view of a chromatographic solvent bottle containing the device of FIG. 3.

### DETAILED DESCRIPTION OF THE PREFERRED EMBODIMENT

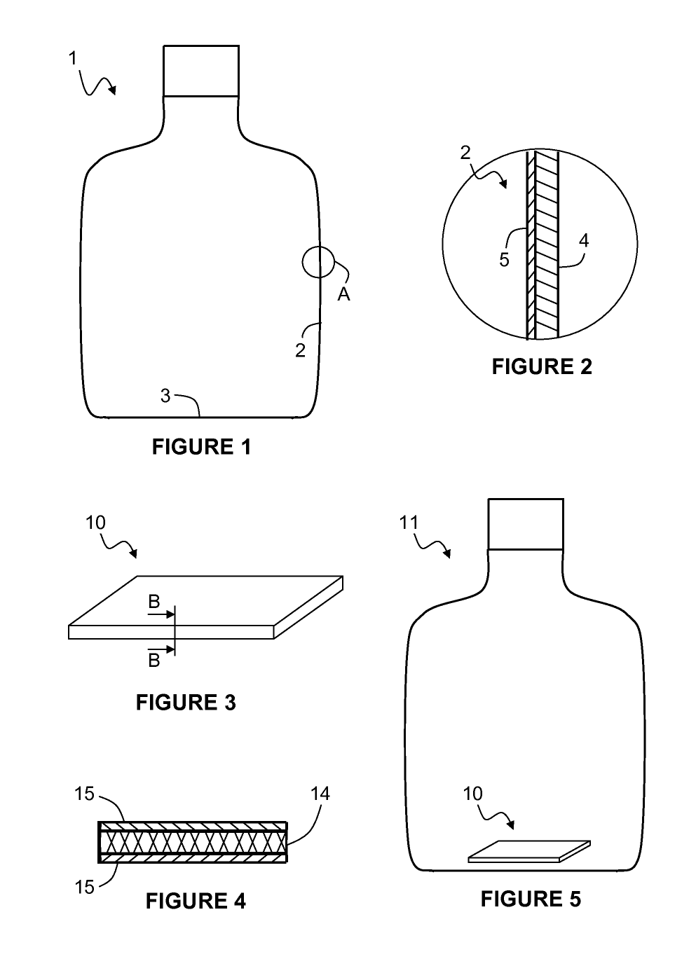

Referring now to FIG. 1, there is shown a chromatographic solvent container 1 in the form of a bottle 1 in this embodiment. The bottle 1 includes has a side wall 2 and base wall 3. As shown more clearly in FIG. 2, the side wall 2 includes a base layer 4, formed of glass in this embodiment, and an antimicrobial layer 5 on the internal surface of the base layer 4.

The antimicrobial layer 5 is a coating 5 that includes sodium azide in this embodiment. The coating 5 is configured for slow gradual release of the sodium azide into the solvent (not shown) contained in the container 1 to prevent or at least inhibit microbial growth. For example, the coating 5 may be covalently attached to the internal surface of the base layer 4. Alternatively or additionally, the coating 5 may be adsorbed on the internal surface of the base layer 4.

Referring now to FIGS. 3 to 5, there is shown an antimicrobial device 10 for use in a standard chromatographic solvent container 11. The device 10 is in the form of a cartridge or plate 10 that includes a substrate 14 with an antimicrobial layer 15 on each of its major surfaces, as shown more clearly in FIG. 4.

The antimicrobial layers 15 in this embodiment include silver nanoparticles, which are known to demonstrate high antimicrobial activity. In use, the antimicrobial device 10 is placed in the container 11 together with the solvent as shown in FIG. 5.

Sparge stones are often used to de-gas mobile phases by sparging helium gas through the mobile phase, thereby displacing dissolved oxygen. It would therefore be beneficial that, in some embodiments, an antimicrobial layer is incorporated on and/or in such sparge stones.

Chromatographic systems use sinkers at the inlet end of tubing used to feed mobile phase from a mobile phase bottle to the system pump. These sinkers are used as relatively large pore size filters in order to prevent particulates from the bottles from entering the chromatographic system. The pore size in these sinkers/filters is generally ten times larger than the size of bacteria (e.g. ˜0.22 μm). Incorporation of a sinker with a pore size small enough to filter bacteria is not possible with current pump designs, which would cavitate and stop working as they would be unable to create enough vacuum to pull mobile phase through such a small pore size.

Both sparge stones and sinkers have similarities in that they are porous structures typically made of stainless steel, titanium or other inert materials. Mixers and/or the tubing may also be provided with an antimicrobial layer. The mixer is used to assist in mixing mobile phases from various pump heads so that the discrete portion delivered from each pump head, which can vary in composition, are blended to a homogeneous mixture before reaching the injector or column inlet.

It will be appreciated by those skilled in the art that several variations to the aforementioned embodiments are envisaged without departing from the scope of the invention. For example, the chromatographic container may comprise a chromatographic sample vial or collection container. The antimicrobial layer 5 may cover some, e.g. a relatively small portion, half, most or all of the internal surface of the container 1. The device 10 may take any number of forms, but the antimicrobial layer 15 is preferably on an exposed surface to permit the layer to interact with, e.g., a solvent contained in the chromatographic container 11.

It will also be appreciated that any number of combinations of the aforementioned features and/or those shown in the appended drawings provide clear advantages over the prior art and are therefore within the scope of the invention described herein.

1. An antimicrobial device for use in a chromatographic system, the device comprising a substrate with a layer thereon that inhibits, in use, microbial growth on the layer or in a container within which the device is at least partially received.

2. The device of claim 1, wherein the layer is on an exposed surface of the device.

3. The device of claim 1, wherein the layer comprises a coating, liner or film.

4. The device of claim 1, wherein the layer is configured to release, in use, an antimicrobial agent or chemical additive.

5. The device of claim 1, wherein the agent or additive comprises sodium azide.

6. The device of claim 1, wherein the layer comprises silver or silver particles.

7. The device of claim 6, wherein the silver or silver particles comprises nanoparticles of silver.

8. The device of claim 1, wherein the device or substrate comprises a cartridge or a plate that includes the layer thereon.

9. The device of claim 1, wherein the device or substrate comprises a mobile phase sinker or a sparge stone or chromatographic tubing or a mixer or other wetted part of a liquid chromatograph.

10. A chromatographic container containing a device according to claim 1.

11. A chromatographic container comprising an antimicrobial layer that inhibits, in use, microbial growth on the layer or in the container.

12. The container of claim 11, wherein the layer is on an internal surface of the container.

13. The container of claim 11, wherein the layer comprises a coating, liner or film.

14. The container of claim 11, wherein the layer is configured to release, in use, an antimicrobial agent or chemical additive.

15. The container of claim 14, wherein the agent or additive comprises sodium azide.

16. The container of claim 11, wherein the layer comprises silver or silver particles.

17. The container of claim 16, wherein the silver or silver particles comprises nanoparticles of silver.

18. The container of claim 11, wherein the container is a solvent bottle, sample vial, or collection container.

19. The container of claim 11, wherein the container contains a solvent.
